(19) United States
(12) Patent Application Publication
(10) Pub. No.: US 2009/0190996 A1
(43) Pub. Date: Jul. 30, 2009

(54) Apparatus for Connecting Structural Members

(75) Inventor: Gregory A. Clarke, London (CA)

Correspondence Address: BERESKIN AND PARR, 40 KING STREET WEST, BOX 401, TORONTO, ON, M5H 3Y2, CA

(73) Assignee: POINTBLANK DESIGN INC., London (CA)

(21) Appl. No.: 12/022,690

(22) Filed: Jan. 30, 2008

(51) Int. Cl. F16B 7/18; E04B 1/38; F16B 7/04

(52) U.S. Cl. 403/188; 403/231; 403/256; 52/656.9

(57) ABSTRACT

A connector apparatus for joining a plurality of structural members, comprising a brace having a web extending lengthwise along at least a portion of a connector axis, the web having laterally opposite first and second web side edges and opposed web front and web back faces extending between the first and second web side edges, a first arm extending forwardly from the first web side edge relative to the front face of the web, the first arm presenting a first arm face, and a second arm extending forwardly from the second web side edge relative to the front face of the web, the second arm presenting a second arm face, wherein the first and second arm faces are inclined outwardly from each other at a first angle. The web may include at least one web aperture therein configured for receiving a fastening device for fastening the brace to at least one of the structural members. A linkage apparatus may be used to secure at least one brace to a plurality of structural members, the linkage apparatus including a first coupling member having a head portion for bearing against the web back face of a first brace of the at least one brace, and a barrel portion for engaging the at least one web aperture in the first brace, and a connector member engagable with the barrel portion of the first coupling member and being shaped for passing through an aperture in at least one of the structural members to secure the first brace against first faces of the structural members.

### FIELD

Disclosed herein are apparatus related to construction, in particular apparatus relating to connecting structural members for use in buildings and other structures.

### BACKGROUND

Structures such as houses and other buildings typically include a number of structural members of different shapes, sizes, materials and orientations that are joined together to create a frame of the structure. For example, vertical structural members (also called posts) may be provided as part of a frame of a structure, extending upwardly away from a ground or other supporting surface to provide support for elevated portions of the structure. The posts may be joined or secured to various other structural members that are oriented at different angles to create different frame configurations. For example, horizontal structural members or beams may be secured to the posts in a perpendicular orientation to provide a frame for floors, roof-elements and other similar horizontal features as desired within the structure. Vertical and horizontal structural members may also be joined to members oriented at other angles that provide other features within the structure, such as angled roof-rafters and the like.

It is common in many structures to use naturally occurring building materials, and beams, posts and other structural elements within a building are often made of timber. Various systems and apparatus for joining timbers and other structural members in different angles or orientations as desired are known such as toe-nailing of beams directly to posts or using L-shaped hanging brackets to secure beams to the sides of posts. Various other apparatus are disclosed in U.S. Pat. Nos. 4,400,925 (Loghem et al.), 4,616,950 (Morris), and 5,741,083 (Schvartz).

However, while various systems and apparatus for joining structural members are known, there is a need for apparatus that provide for improved joining of structural members, particularly timbers, for use in the construction of buildings and other structures.

### SUMMARY

The following summary is intended to introduce the reader to this specification, but not to define any invention. In general, this specification generally discloses apparatus for securing together two or more structural members.

One aspect of the present invention is a brace for joining a plurality of structural members, the brace having a web extending lengthwise along at least a portion of a connector axis, the web having laterally opposite first and second web side edges and opposed web front and web back faces extending between the first and second web side edges, a first arm extending forwardly from the first web side edge relative to the front face of the web, the first arm presenting a first arm face, and a second arm extending forwardly from the second web side edge relative to the front face of the web, the second arm presenting a second arm face, wherein the first and second arm faces are inclined outwardly from each other at a first angle.

In some embodiments, the first angle may be between 45 and 135 degrees. In some examples, the first angle may be approximately 90 degrees.

The web may include at least one web aperture therein configured for receiving a fastening device for fastening the brace to at least one of the structural members. The at least one web aperture may include a first web aperture located in a first portion of the web for securing the brace to a first structural member, and a second web aperture located in a second portion of the web for securing the brace to a second structural member.

At least one of the structural members may have first engagement surfaces and second engagement surfaces spaced from the first engagement surfaces, and the first arm face may be configured for bearing against the first engagement surfaces and the second arm face may be configured for bearing against the second engagement surfaces.

In some examples, the first angle may be a pressure angle, and the first and second engagement surfaces may be inclined relative to each other at a second engagement angle corresponding to the pressure angle. The first engagement surfaces and second engagement surfaces may be located in spaced apart grooves provided in one or more faces of the structural members.

A portion of the first arm and a portion of the second arm may extend rearwardly of the web to define a cap portion, wherein the cap portion is provided with a longitudinal channel extending lengthwise of the brace, the channel being defined by at least the back face of the web, an interior surface of the first arm, and an interior surface of the second arm. The cap portion may have at least one cap aperture therein in registration with at least one web aperture in the web. The at least one cap aperture may be larger in diameter than the at least one web apertures and may be configured to receive the fastening device such that the fastening device may bear against the back face of the web.

At least one arm aperture may be provided in at least one of the first arm and the second arm, the at least one arm aperture for receiving at least one arm fastener to further secure the brace to at least one of the structural members.

Another aspect of the invention is a connector apparatus for joining a plurality of structural members, including a brace comprising a web extending lengthwise along at least a portion of a connector axis, the web having laterally opposite first and second web side edges and opposed web front and web back faces extending between the first and second web side edges, the web having at least one web aperture therein, a first arm extending forwardly from the first web side edge relative to the front face of the web, the first arm presenting a first arm face, and a second arm extending forwardly from the second web side edge relative to the front face of the web, the second arm presenting a second arm face, wherein the first and second arm faces are inclined outwardly from each other at a first angle, and a fastening device shaped for engaging the web and for extending through at least one web aperture and at least one of the structural members so as to secure the brace to the structural members.

The fastening device may include a coupling having a head portion shaped to bear against the back face of the web and a connector member securable to the coupling and shaped to extend through the at least one structural member to secure the brace to the structural members. The coupling may include a barrel having a threaded bore, and the connector member comprises a threaded rod portion shaped to releasably engage the threaded bore of the barrel.

The threaded bore of the barrel may be configured to bear against a passageway in at least one structural member, and may tend to inhibit joint separation between two or more structural members.

In some examples, the first angle may be a pressure angle, and at least one of the structural members may have first engagement surfaces and second engagement surfaces spaced from the first engagement surfaces and inclined relative to the first engagement surfaces at a second engagement angle corresponding to the pressure angle, the second engagement angle selected such that the first arm face bears against the first engagement surfaces on the at least one structural member and the second arm face bears against the second engagement surfaces on the at least one structural member when the brace is secured to the structural members.

Another aspect of the invention is a connector apparatus for a joint having at least two structural members, the connector apparatus comprising a first brace and a second brace positionable in an opposing relationship on opposite faces of the structural members, each brace comprising a web extending lengthwise along at least a portion of a connector axis, the web having laterally opposite first and second web side edges and opposed web front and web back faces extending between the first and second web side edges, the web having at least one web aperture therein, a first arm extending forwardly from the first web side edge relative to the front face of the web, the first arm presenting a first arm face, and a second arm extending forwardly from the second web side edge relative to the front face of the web, the second arm presenting a second arm face, wherein the first and second arm faces are inclined outwardly from each other at a first angle, and a fastening device shaped for engaging the webs of the first and second braces and shaped for extending through the at least one web aperture and at least one of the structural members and being adjustable to selectively urge the opposing first and second braces towards each other to bear against the opposite faces of the structural members.

The fastening device may include a linkage apparatus having a first coupling for bearing against the first brace, a second coupling for bearing against the second brace, and a connector member for engaging with the first coupling and the second coupling to draw the first and second couplings towards each other to selectively urge the opposing first and second braces to bear against the opposite faces of the structural members. Each of the first coupling and the second coupling may include a head portion for bearing against the back face of the webs of the first and second braces, and a barrel portion connected to the head portion and shaped for engaging the at least one web aperture the barrel portion having a threaded bore, wherein the connector member comprises a threaded rod portion releasably securable to the threaded bore of the barrel portion in the first and second couplings and being shaped for extending through an aperture in the at least one structural member to join the first brace to the second brace.

Another aspect of the invention is a structural joint, comprising a first structural member having a first abutment face, and a first front face, a second structural member having a second abutment face for engaging the first abutment face of the first structural member, and a second front face generally coplanar with the first front face when the second abutment face engages the first abutment face, at least one brace having a first portion for engaging the first front face, and a second portion for engaging the second front face, the at least one brace comprising a web extending lengthwise along at least a portion of a connector axis, the web having laterally opposite first and second web side edges and opposed web front and web back faces extending between the first and second web side edges, the web having at least one web aperture therein, a first arm extending forwardly from the first web side edge relative to the front face of the web, the first arm presenting a first arm face, and a second arm extending forwardly from the second web side edge relative to the front face of the web, the second arm presenting a second arm face, wherein the first and second arm faces are inclined outwardly from each other at a first angle, and at least one fastening device couplable to the web of the at least one brace and for extending through the at least one web aperture, the fastening device configured for securing the at least one brace against the first and second front faces of the first and second structural members.

The first and second structural members of the timber joint may include first engagement surfaces and second engagement surfaces spaced apart from the first engagement surfaces and inclined with respect to the first engagement surfaces at a second engagement angle, wherein the first and second arm faces of the at least one brace are configured to bear against the first and second engagement surfaces respectively when the at least one brace is secured against the first and second front faces of the first and second structural members.

Yet another aspect of the invention is a linkage apparatus for use in securing at least one brace to a plurality of structural members, the at least one brace having a web extending lengthwise along at least a portion of a connector axis, opposed web front and web back faces, and at least one web aperture therein, the linkage apparatus comprising a first coupling member having a head portion for bearing against the web back face of a first brace of the at least one brace, and a barrel portion for engaging the at least one web aperture in the first brace, and a connector member engagable with the barrel portion of the first coupling member and being shaped for passing through an aperture in at least one of the structural members to secure the first brace against first faces of the structural members.

The linkage apparatus may further comprise a second coupling member opposite the first coupling member, and wherein the barrel portion of the first coupling comprises a threaded bore, and the connector member comprises a threaded rod portion shaped to releasably engage with the threaded bore of the barrel portion and being adjustable to selectively urge the first and second couplings towards each other to bear the first brace against the first faces of the plurality of structural members

The head portion of the first coupling member may have a cross-bore, and may further comprise a locking fastener for engaging with the cross-bore when the first coupling member is engaged with the structural members, the locking fastener being configured to inhibit rotation of the first coupling member. The cross-bore may have an internally threaded portion and the locking fastener may have a threaded portion for releasably engaging with the internally threaded portion.

### BRIEF DESCRIPTION OF THE DRAWINGS

For a better understanding of the embodiments, and to show more clearly how they may be carried into effect, reference will now be made, by way of example, to the accompanying drawings, in which:

FIG. 1 is a perspective view of two structural timber members joined using a pair of braces to form a timber joint according to one embodiment;

FIG. 2 is an exploded perspective view of the timber joint of FIG. 1;

FIG. 3 is a perspective view of one of the braces used in the timber joint shown in FIG. 1;

FIG. 4 is a front elevation view of the brace of FIG. 3;

FIG. 5 is a cross-sectional view of the brace of FIG. 4 taken along lines 5-5;

FIG. 6 is a front elevation view of the timber joint of FIG. 1;

FIG. 7 is a partially exploded plan view of a portion of the timber joint of FIG. 6;

FIG. 8 is a front end view of a coupling of a linkage apparatus used for securing the braces to the structural members in the timber joint shown in FIG. 1;

FIG. 9 is a cross-sectional view of the coupling of FIG. 8 taken along the line 9-9;

FIG. 10 is a back end view of the coupling of FIG. 9 taken along line 10-10;

FIG. 11 is a top view of the timber joint of FIG. 1 showing anchoring fasteners passing through arm holes to secure the brace to the horizontal timber member;

FIG. 12 is a perspective view of three structural timber members joined using a pair of braces to form a timber joint according to another embodiment;

FIG. 13 is a front elevation view of a portion of the timber joint of FIG. 12;

FIG. 14 is a perspective view of four structural timber members joined using braces to form a timber joint according to yet another embodiment;

FIG. 15 is a front elevation view of the timber joint of FIG. 14;

FIG. 16 is a bottom view of an uppermost structural beam member of the timber joint of FIG. 14;

FIG. 17 is a cross-sectional view of the timber joint of FIG. 15 taken along the line 17-17;

FIG. 18 is an exploded perspective view of a timber joint according to yet another embodiment;

FIG. 19 is a front elevation view of a timber joint to yet another embodiment;

FIG. 20 is a top view of the timber joint of FIG. 19;

FIG. 21 is a side elevation view of a portion of the timber joint of FIG. 20;

FIG. 22 is a perspective view of a timber joint having braces according to another embodiment;

FIG. 23 is a cross-sectional view of a brace for joining structural members to form a timber joint according to another embodiment;

FIG. 24 is an end view of the brace of FIG. 23;

FIG. 25 is a cross-sectional view of a timber joint using the brace of FIG. 23 according to another embodiment;

FIGS. 26 to 32 are side views of timber joints according to various other embodiments; and

FIG. 33 is a perspective view of a brace for joining structural members to form a timber joint according to another embodiment.

### DETAILED DESCRIPTION OF VARIOUS EMBODIMENTS

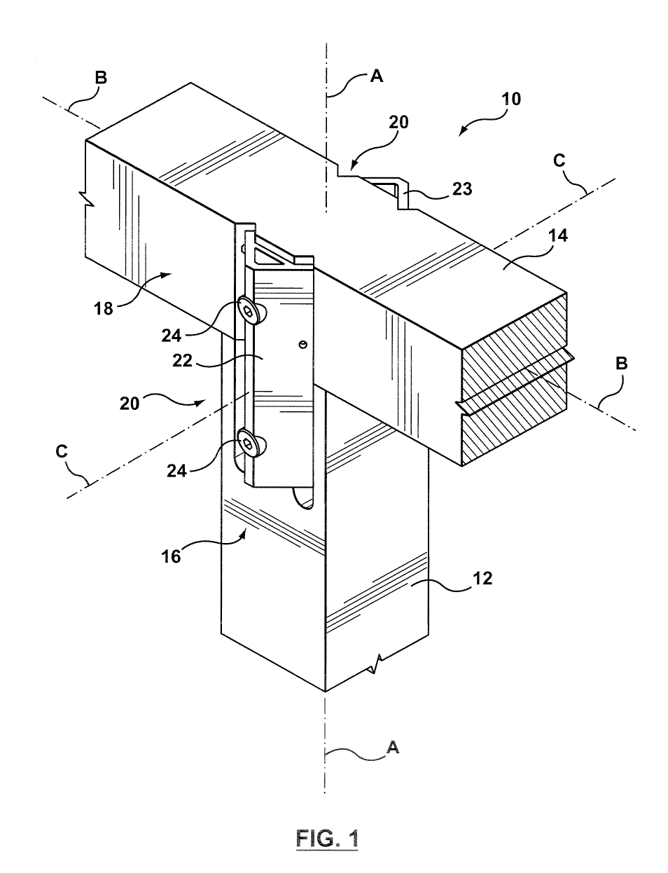

Referring to FIG. 1, according to one embodiment, a plurality of timber structural members are joined together using braces to form a timber joint 10. It will be appreciated that while various embodiments described herein reference timber structural members, a person of skill in the art would understand that various other structural members could be substituted.

The timber joint 10 comprises a vertical first timber member or post 12 and a horizontal second timber member or beam 14 mounted atop the post 12 and being generally perpendicular to the post 12. The post and beam 12, 14 have respective first and second front faces 16 and 18 that are generally coplanar, and as shown are generally aligned in a vertical plane. Defined with respect to the timber joint 10 are several joint axes, including a longitudinal joint axis A that is generally parallel to the longitudinal axis of the vertical post 12, a transverse joint axis B generally parallel to the longitudinal axis of the horizontal beam 14, the joint axis B perpendicular to and intersecting the longitudinal joint axis A, and a normal joint axis C generally perpendicular to both the longitudinal and transverse joint axes A, B, and also passing through the intersection of joint axis A and joint axis B.

As described in further detail below, the first and second timber members 12, 14 are held together by a connector apparatus 20 that generally includes at least one brace (such as braces 22, 23) and at least one fastener for securing the braces to the structural members (such as linkage apparatus 24).

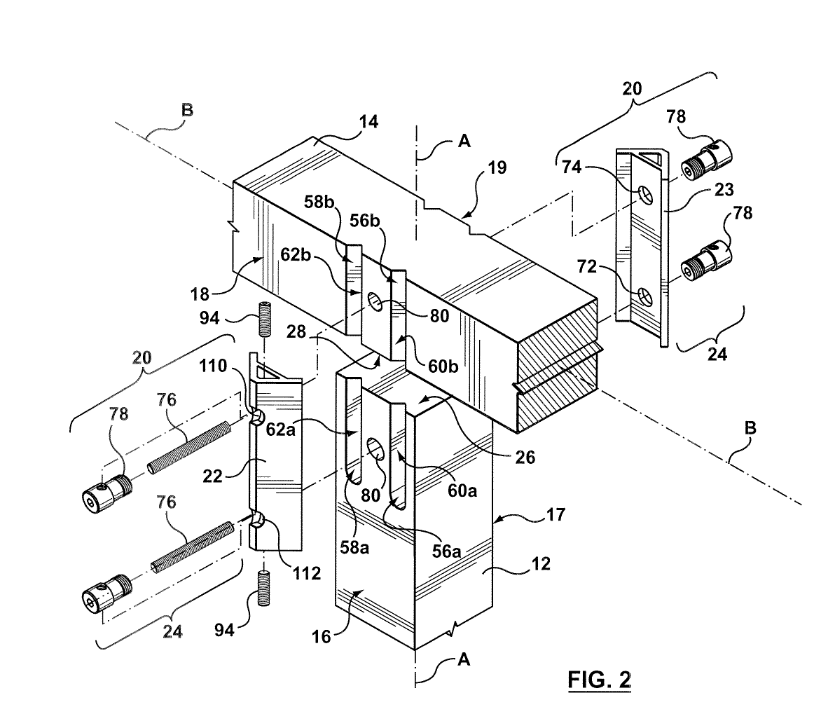

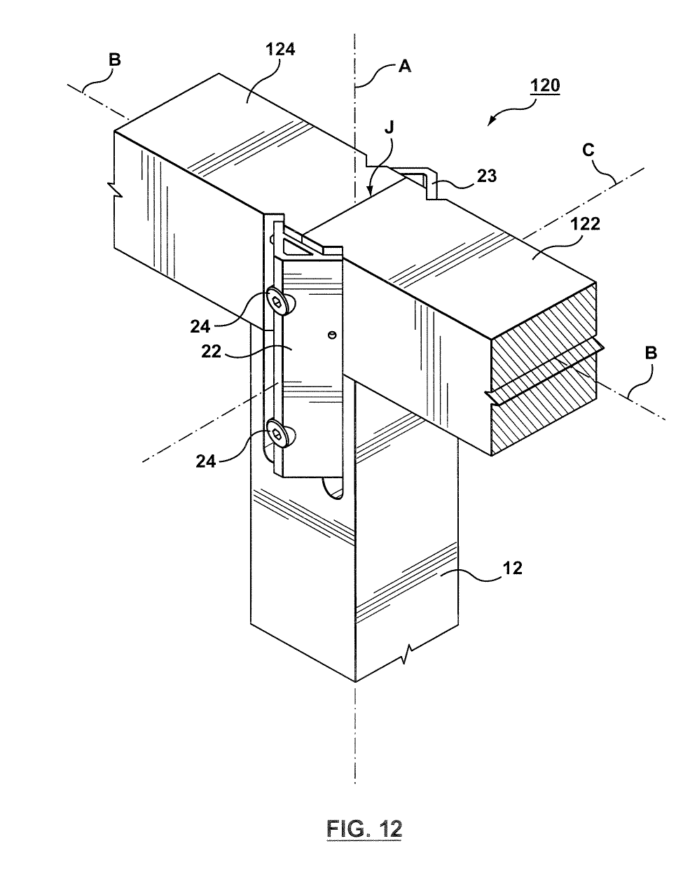

Referring now also to FIG. 2, the post 12 generally has a support surface 26, or abutment surface, defined by an end face at an upper end of the post 12. The beam 14 has a corresponding abutment surface 28, provided as a bottom surface of the beam 14, and which is configured to bear against the support surface 26 of the post 12 when the beam 14 and post 12 are joined in the timber joint 10. According to some embodiments, the post 12 and beam 14 may be of one-piece construction or two-piece construction (e.g. with two separate members, as shown for example in FIG. 12).

During use, the connector apparatus 20 generally operates to hold together the post 12 and beam 14 to form the timber joint 10 and to inhibit relative movement of the post 12 and beam 14. The connector apparatus 20 generally includes at least one brace 22 mounted against at least one of the front side faces 16, 18 of the timbers 12, 14. In the example illustrated in FIG. 2, for example, the connector apparatus 20 may include two braces 22, 23, with the first brace 22 mounted against the front side faces 16, 18 of the timbers 12, 14, and the second brace 23 mounted in an opposing relation on rear side faces 17, 19 of the timber members 12, 14. During use, a fastener or fastening device, such the linkage apparatus 24, may be used to squeeze the timbers 12, 14 between the braces 22, 23 to provide for a secure timber joint 10, as will be described in more detail below.

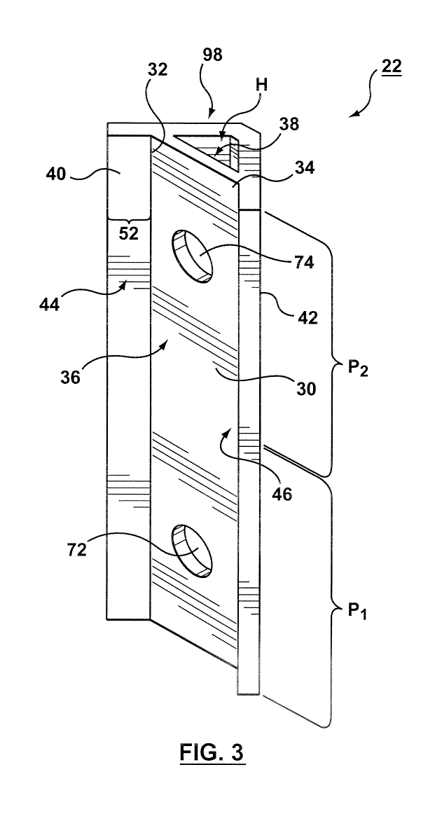

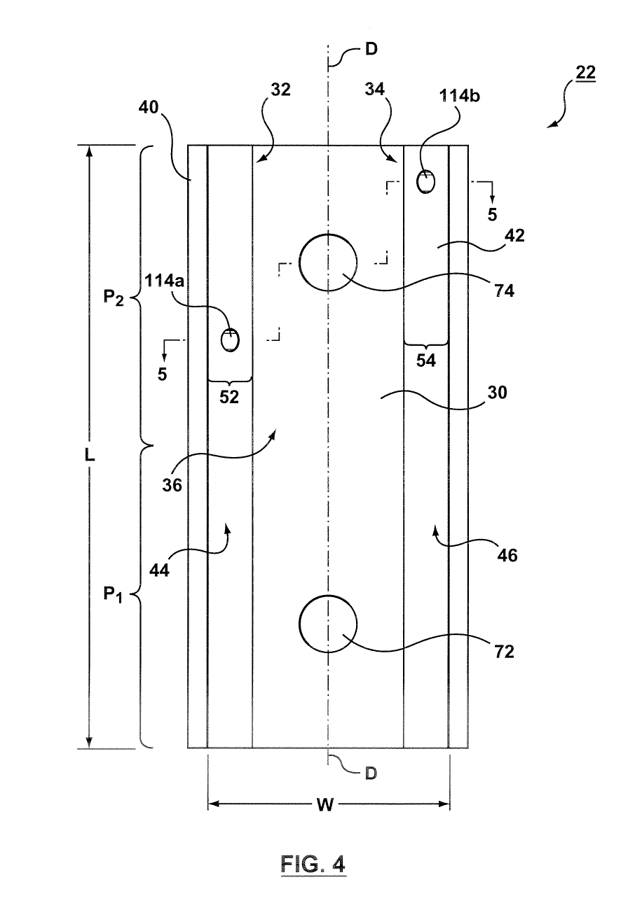

Referring now also to FIGS. 3, 4 and 5, each brace 22 generally has an elongate shape generally defined by a brace width W and a brace length L extending lengthwise along a longitudinal connector axis D as shown in FIG. 4.

It will be appreciated that brace 23 is substantially similar to brace 22.

The brace 22 generally includes an elongate transverse portion or web 30 extending longitudinally at least a portion of the connector axis D of the brace 22. The web 30 is generally plate-like, and includes laterally spaced-apart first and second web side edges 32, 34, a web front face 36 and an opposing web back face 38, the front face 36 and back face 38 extending between the first and second web side edges 32, 34. In some embodiments, the web 30 may be continuous along the connector axis D, as shown. In other embodiments, the web 30 may be discontinuous, with apertures extending across the web 30 between the side edges 32, 34.

The brace 22 generally also includes a first arm 40 located at the first web side edge 32, and a second arm 42 located at the second web side edge 34. The first arm 40 and second arm 42 are each generally inclined outwardly at an obtuse angle with respect to the web front face 36. According to some embodiments, the first and second arms 40, 42 may be formed separately from web 30 and be joined to the web 30 during an assembly step, such as by welding. In other embodiments, the first and second arms 40, 42 may be formed integrally with the web 30, such as by an extrusion or a casting process.

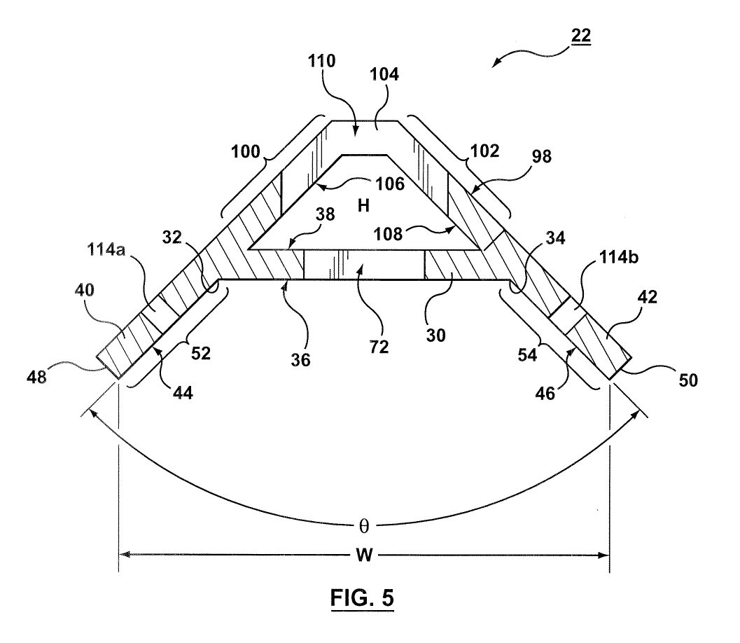

The first and second arms 40, 42 present a first arm face 44 and a second arm face 46, respectively. As shown, the arm faces 44, 46 may be generally planar in shape and inclined outwardly from each other at a first angle known as a pressure angle θ, as shown in FIG. 5. The arm faces 44, 46 may extend forwardly relative from the front face 36 of the web 30. According to some embodiments, the brace width W is selected in proportion to the spacing between the first and second arm surfaces 44, 46 of the arms 40, 42 at their distal ends 48, 50.

According to some embodiments, the pressure angle θ may be in the range of about 45 degrees to about 135 degrees. According to other embodiments, the pressure angle θ may be in the range of about 75 degrees to about 105 degrees. In other embodiments, the pressure angle θ may be in the range of about 85 degrees to about 95 degrees. In the example illustrated, the pressure angle θ is approximately 90 degrees.

As shown, the front face 36 of the web 30 may be generally planar, and the first and second arm faces 44, 46 may each be inclined forwardly relative to the front face 36 by an angle equal to about one half of the pressure angle θ.

In some embodiments, each arm 40, 42 generally has a respective distal end 48, 50 away from each respective web side edge 32, 34, and which extends lengthwise of the brace 22 generally parallel to the connector axis D. Each arm 40, 42 also generally has a respective lateral extent 52, 54 extending between the distal ends 48, 50 and the respective web side edge 32,34, and which provides the first arm face 44 and second arm faces 46, respectively.

As best shown in FIGS. 3 and 4, according to some embodiments the brace 22 may generally be considered to have a lower first portion P₁ and an adjacent upper second portion P₂ along the length L of the brace 22. The distinct first and second portions P₁, P₂ are configured such that the brace 22 may be brought to bear against two or more distinct structural members, such as the post 12 and beam 14, respectively, to form the timber joint 10.

According to some embodiments, the brace 22 may be made of a metal, such as steel or aluminum. In other embodiments, the brace 22 may be made of any other suitable material having sufficient strength and rigidity to adequately secure the post 12 and beam 14 together. For example, the brace 22 may be made of a thermoplastic or thermoset, a composite material such as carbon fiber, and so on. In some examples, the brace 22 may be substantially rigid. In other examples, the brace 22 may be somewhat resilient.

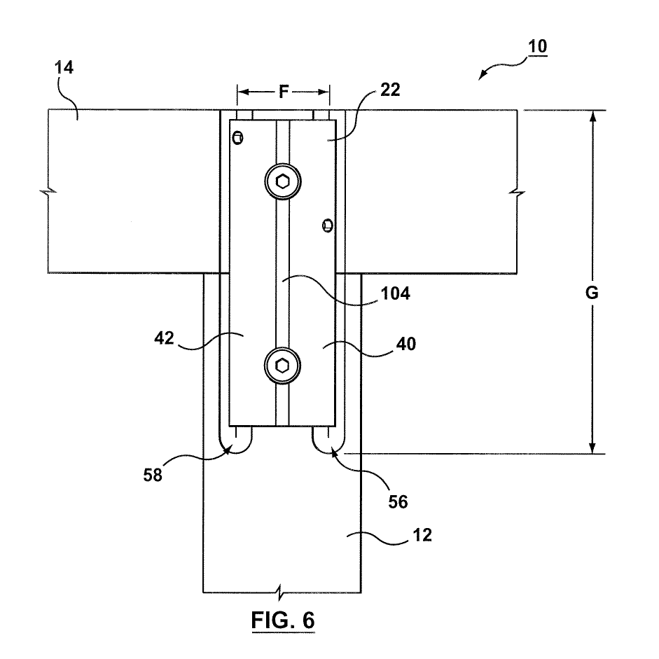

According to some embodiments for example as shown in FIG. 6, the first and second timber members 12, 14 of the timber joint 10 are provided with first and second grooves 56, 58 generally configured for receiving the first and second arms 40, 42, respectively, of the brace 22. The grooves 56, 58 are generally equal in length, with a groove length G of sufficient length to accommodate the length of the arms 40, 42 of the brace 22 within the grooves 56, 58. As shown, groove length is slightly longer than the brace length L.

Timber members such as vertical post 12 and horizontal beam 14, may be prone to settle or shift for various reasons, for example depending upon weather conditions (since wood may tend to swell or shrink depending on the moisture in ambient air), temperature, shifting ground surfaces, and so on. This shifting may be accommodated in some embodiments as the braces 22, 23 provided within the grooves 56, 58 may allow for some relative sliding movement of the post 12 and beam 14 parallel to the joint axis A, while still maintaining a clamping force between the braces 22, 23 and without disengagement of the braces 22, 23. Allowing this sliding movement may reduce stresses generated in the timbers 12, 14 or the braces 22, 23, which may otherwise increase the risks of failure. In some embodiments, it may be desirable that the groove length G be greater than the brace length L to accommodate the relative sliding movement.

According to some embodiments, the first and second grooves 56, 58 may be provided by two or more groove segments, each provided in one of the timber members 12, 14. For example, as best shown in FIG. 2, the first groove 56 may include a first groove segment 56a in the post 12, and a second groove segment 56b in the beam 14. Similarly, the second groove 58 may include a first groove segment 58a in the post 12 and a second groove segment 58b in the beam 14. When the timbers 12, 14 are joined to form the timber joint 10, the first groove segments 56a, 58a are generally aligned with the respective second groove segments 56b, 58b to provide the grooves 56, 58 with a generally coplanar configuration which allows for relative sliding movement of the braces 22, 23 within the grooves 56, 58.

As best shown in FIG. 7, the first and second grooves 56, 58 may be generally V-shaped in cross-section, having respective first and second engagement surfaces 60, 62 on one side of the “V”. The first and second engagement surfaces 60, 62 may be configured to engage the arm faces 44, 46 of the brace 22 during use. It will be understood that the grooves 56, 58 could have different cross-sections, and that a V-shape is not intended to be essential.

According to some embodiments, as shown in FIG. 2 each engagement surface 60, 62 may include first portions 60a, 62a provided in the first groove segments 56a, 58a in the post 12, and second portions 60b, 62b provided in the second groove segments 56b, 58b in the beam 14. When the post and beam 12, 14 are aligned to be joined, the first engagement surfaces 60a, 62a, and second engagements surfaces 60b, 62b tend to form generally continuous, coplanar first and second engagement surfaces 60, 62 for engagement with the arm faces 44, 46.

The first and second engagement surfaces 60, 62 may be angularly inclined relative to each other by an engagement angle φ. In some examples, the engagement angle φ may correspond to the pressure angle θ. As shown, the engagement angle φ is approximately equal to pressure angle θ between the arm faces 44, 46.

According to some embodiments, opposite the engagement surfaces 60, 62 in the grooves 56, 58 are free walls 64, 66. The engagement surfaces 60, 62 and the free walls 64, 66 may meet at first and second groove apexes 68, 70, and together the engagement surfaces 60,62 and free walls 64, 66 define the grooves 56, 58 extending inwardly from the front faces 16, 18 into the post 12 and beam 14.

The free walls 64, 66 are shaped such that they generally do not come into contact with or inhibit the movement of the braces 22, 23. Rather, they are intended to provide sufficient room such that the braces 22, 23 may be inserted into the grooves 56, 58 to abut the engagement surfaces 60, 62. In some embodiments, the free walls 64, 66 may be inclined in mirror image to the respective engagement surfaces 60, 62, providing the grooves 56, 58 with a generally V-shaped cross-sectional profile.

It will be understood that, while the engagement surfaces 60, 62 and the free walls 64, 66 are shown having V-shaped cross sectional profiles generally meeting at first and second groove apexes 68, 70, this is not meant to limit the shape of grooves 56, 58. In particular, it is not essential that the grooves 56, 58 have groove apexes 68, 70. For example, the grooves 56, 58 could have rounded inner surfaces. Furthermore, the free walls 64, 66 need not be provided as shown, and could have any other suitable shape or even be entirely absent.

As best shown in FIG. 7, the grooves 56, 58 may be spaced laterally apart as defined by a groove width F. As will be appreciated upon inspection of FIGS. 5 and 7, the groove width F may be selected to be at least as large as the brace width W such that when the brace 22 is engaged against the front surface 18 of a timber member 14 (as shown in dashed lines in FIG. 7), there exists a brace gap E between the first and second distal ends 48, 50 of the arms 40, 42 and the free walls 64, 66. The brace gap E allows the braces 22, 23 to squeeze the post 12 and beam 14 between them without the distal ends 48, 50 of the braces 22, 23 interfering with or being obstructed by the free walls 64, 66. The groove width F may be selected such that the braces 22, 23 may apply sufficient squeezing force to ensure the timber joint 10 is secure while still retaining a positive brace gap E.

During use, the engagement surfaces 60, 62 cooperate with the braces 22, 23 and tend to resist relative shearing movement between the post 12 and the beam 14. For example, movement of the beam 14 along the transverse joint axis B, relative to the post 12, may be resisted by the first and second engagement surfaces 60a, 62a in the post 12 and the first and second engagement surfaces 60b, 62b in the beam 14. For example, any movement of the beam 14 in a first direction along the joint axis B (generally from the first groove 56 towards the second groove 58), will be resisted by the second engagement surface 62b of the beam 14 tending to bear against an upper portion of the second front face 46 (in the second portion P₂) in the second arm 42, while the first engagement 60a of the post 12 will tend to bear against a lower portion of first front face 44 (in the first portion P₁) of the opposite arm 40. Similarly, movement of the beam 14 along the joint axis B in the opposite direction will tend to be resisted by the first engagement surface 60b in the beam 14 and the second engagement surface 62a in the post 12 bearing against an upper portion of the first front face 44, and a lower portion of the second front face 46.

Referring again to FIGS. 2, 3, 4 and 5, according to some embodiments, each brace 22, 23 is provided with at least one web aperture in the web 30, such as first and second web apertures 72, 74, to secure the brace 22 to the post 12 and beam 14. As shown, the first web aperture 72 is provided in the first portion P₁ of the brace 22, and the second web aperture 74 is provided in the second portion P₂ of the brace 22. As shown, the first web aperture 72 may be used to secure the brace 22 to the post 12, while the second web aperture 74 may be used to secure the brace 22 to the beam 14.

The web apertures 72, 74 are generally configured to receive one or more fasteners, such as the linkage apparatus 24 or other suitable fasteners or fastening devices, in order to secure the braces 22, 23 to the timber members 12, 14 to form the timber joint 10. As described in further detail below, according to some embodiments the web apertures 72, 74 are sized to engage with a coupling 78 of the linkage apparatus such that a barrel portion 84 of the coupling may engage with or pass through the web apertures 72, 74 while a head portion 82 of the coupling 78 bears against the back face 38 of the web 30 without passing through the web apertures 72, 74.

The linkage apparatus 24 will now be described with particular reference to FIGS. 2, 8, 9 and 10. Each linkage apparatus 24 may include a connector member 76 that has a threaded rod portion configured for threadable engagement with opposed couplings 78 provided at either end of the connector member 76. The couplings 78 may be configured to bear against the braces 22, 23 to provide the desired squeezing forces to the post 12 and beam 14.

According to some embodiments, the connector members 76 pass through the timber members 12, 14 to connect the couplings 78 via passageways 80. Passageways 80 may extend though the timber members 12, 14, generally parallel to the transverse axis C, and allow braces 22, 23 to be secured together.

Each linkage apparatus 24 may be secured to the braces 22, 23 at each end using the couplings 78, and may be configured to be adjustable to draw the opposed couplings 78 together along the connector member 76, causing the braces 22, 23 to be urged snugly against the respective front and rear side faces 16, 17, 18, 19 of the timber members 12, 14, squeezing the timber members 12, 14.

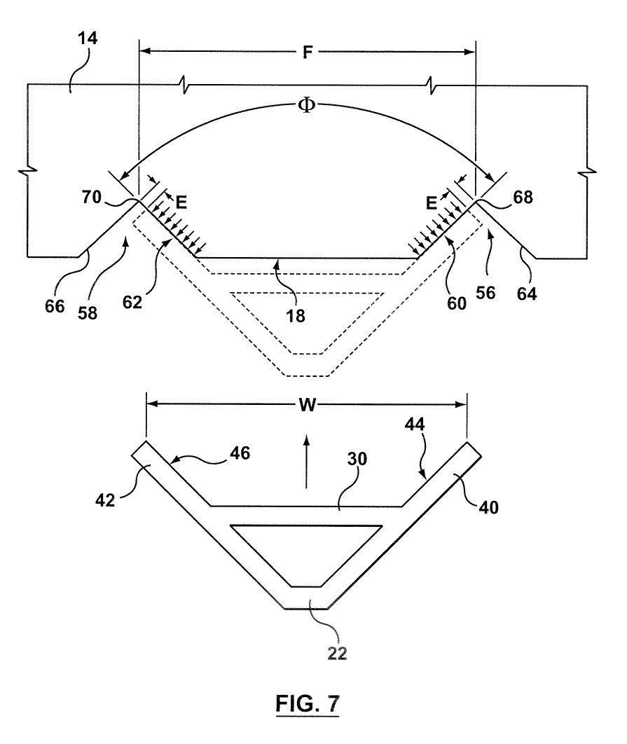

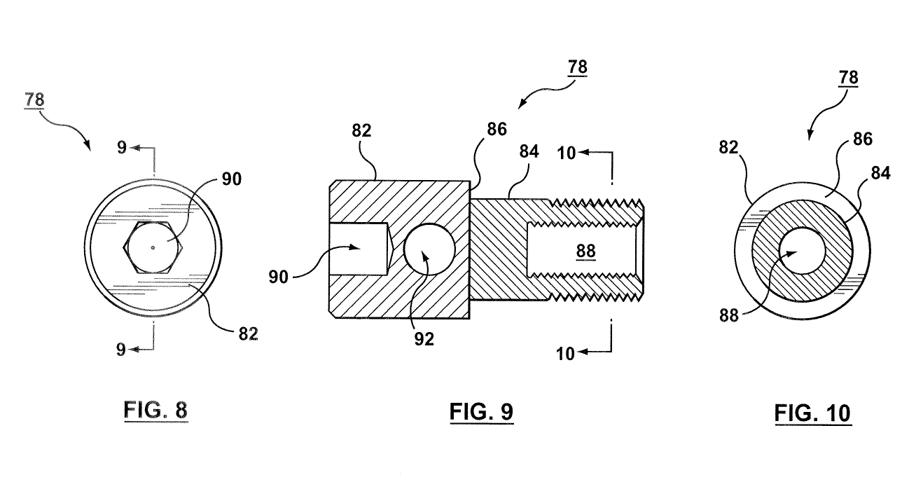

As shown in FIGS. 8 to 10, each coupling 78 generally has a head 82 portion at one end and a barrel 84 portion extending from the head 82. The head 82 and barrel 84 may be generally cylindrical in shape, with the barrel 84 being of a narrower diameter than the head 82 such that a shoulder 86 is defined at the transition between the head 82 and the barrel 84.

According to some embodiments, the barrel 84 has a longitudinal bore 88 that may be internally threaded to receive one end of a threaded portion of the connector member 76 in threaded engagement.

In some embodiments, the barrel 84 may also be externally threaded for engaging with the passageways 80 in the post 12 and beam 14. Engagement between the barrel 84 and the passageways in the post 12 and beam 14 may tend to inhibit unwanted movement of the beam 14 away from the post 12. For example, the threaded barrel 84 may be configured to engage with the passageways 80 in at least one structural member to inhibit joint separation between the post 12 and beam 14 along the longitudinal joint axis A.

Alternatively, in other embodiments, the barrel 84 may be sized and shaped to fit snuggly within the passageways 80 in the post 12 and beam 14 without external threads on the barrel 84.

Alternatively, in other embodiments, the distance between the passageway 80 in the post 12 and the passageway 80 in the beam 14 may be selected to be greater than the distance between the web apertures 72 and 74. In such embodiments, as the braces 22, 23 are tightened, the post 12 and beam 14 will tend to be drawn towards each other (along the longitudinal joint axis A) by the barrels 84 acting against the passageways 80. In some embodiments, the tightening could be accomplished by alternatively tightening each of the braces 22, 23.

Alternatively, in other embodiments, the barrel 84 may be sized and shaped to fit loosely within the passageways 80 to allow for some movement of the barrel 84 within the passageways 80, for example where some joint separation can be accommodated.

According to some embodiments, the head 82 of each coupling 78 may include a grip portion 90 for engagement with a tool or otherwise to turn the coupling 78 relative to the rod 76 and/or opposite coupling 78 during tightening of the linkage apparatus 24 to secure the timber joint 10. The grip portion 90 may be generally provided as any suitable gripping device, such as an external texture or knurled surface provided on the exterior of the head 82 (and which may allow the head 82 to be tightened by hand), an interior feature such as a slot, a hex socket a Robertson™ shaped recess Torx™ shaped recess or another recessed shape provided in the head 82 of the coupling 78, any combination thereof, or any other suitable alternatives.

According to some embodiments, the head 82 may also include a cross bore 92. In some examples, the cross-bore 92 may have an internally threaded portion. As discussed in greater detail below, the cross bore 92 allows a transverse fastener 94, such as a threaded set-screw, rod, pin or other suitable fastener, to be received into the head 82 generally in parallel to the longitudinal joint axis A. As described in greater detail below, the transverse fastener 94 may be used to assist in securing the linkage apparatus 24 to the braces 22, 23 by inhibiting rotation of the couplings 78 relative to each other, and/or relative to the rod 76, and/or relative to the braces 22,23.

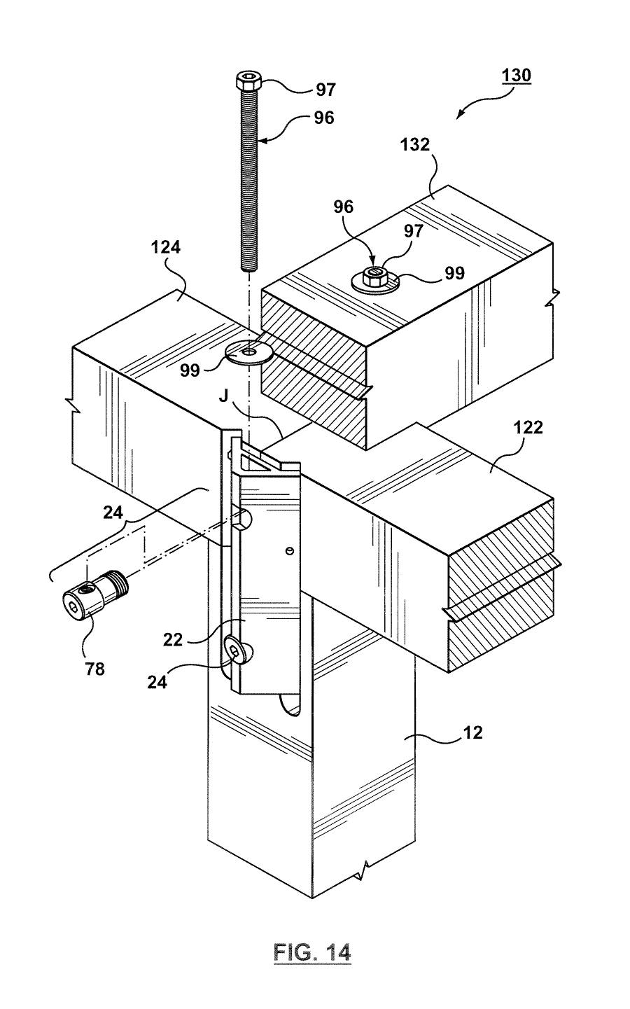

In some embodiments, the transverse fastener may be a threaded tie bolt 96 or other fastener of sufficient length that may be received in the cross bore 92 for use in securing an additional beam member to the joint, as described below with reference to FIG. 14.

Each web aperture 72, 74 may be sized large enough to receive the barrel 84 of the coupling 78 therethrough, but sized small enough such that the head 82 of the coupling 78 cannot pass through the web aperture 72. When in use, the shoulder 86 of the coupling 78 may bear against the back face 38 of the web 30 surrounding the web aperture 72, preventing the head 82 from passing through the web aperture 72 and allowing a squeezing force to be applied between the braces 22, 23 as the linkage apparatus 24 is tightened.

Returning to FIG. 5, according to some embodiments, the first and second arms 40, 42 of the brace 22 may extend rearwardly of the rear face 38 of the web 30 to define a cap portion, as indicated generally as 98.

As shown, the cap portion 98 may generally cover the back face 38 of the web 30, with first and second rear arm portions 100, 102 extending rearwardly from the first and second side edge 32, 34 of the web 30, and converging along a spine member 104. In such embodiments, the brace 22 may form an A-shape in cross-section.

The cap portion 98 of the brace 22 may define an elongate channel H that extends generally lengthwise of the brace 22 along to the connector axis D. As shown in FIG. 5, the channel H is generally bounded by the back face 38 of the web 30, a first interior surface 106 of the first rear arm portion 100, a second interior surface 108 of the second rear arm portion 102, and in some embodiments an inner wall of the spine member 104. As shown, at least one end of the channel H may be open so that transverse fasteners 94, such as a set screw or tie bolt 96 may be received within the channel H to engage with the cross-bore 92 in each coupling 78.

In some examples, the transverse fastener 94 may cooperate with the channel H, to inhibit unwanted rotation of the couplings relative each other and to the rod 76. For example, a set-screw may be inserted into the cross-bore 92 within the channel H such that a portion of the set-screw protrudes radially outward from the outer circumferential surface of the head 82 and will abut the walls of the channel H to inhibit rotation.

According to some embodiments, the cap portion 98 is provided with cap apertures 110, 112 therein spaced along the spine 104 of the braces 22. The cap apertures 110, 112 may be in registration with the web apertures 72, 74 in the web 30. The cap apertures 110, 112 may be larger in diameter than the web apertures 72, 74 and configured to receive the head 82 of the couplings 78 within the cap apertures 110, 112 such that the shoulder 86 of the couplings 78 may abut the back face 38 of the web 30 during use.

Referring now to FIGS. 5, 6 and 11, according to some embodiments the brace 22 may be provided with one or more optional arm apertures or holes 114 including at least a first arm hole 114a in the first arm 40 and a second arm hole 114b in the second arm 42. The one or more arm holes 114 may be provided in one or more of the portions P₁, P₂ of the brace 22. According to some embodiments, the arm holes 114 may be used to further secure the braces 22, 23 to the structural members 12, 14 in the timber joint 10. For example, each of the arm holes 114a, 114b may be positioned at distinct positions along the length L of the brace 22 in some embodiments, for example as shown in FIG. 6, the arm holes 114a, 114b may be positioned within the same portion of the brace 22, such as the second portion P₂. In other embodiments, the arm holes 114a, 114b may be positioned in multiple or different portions of the brace 22.

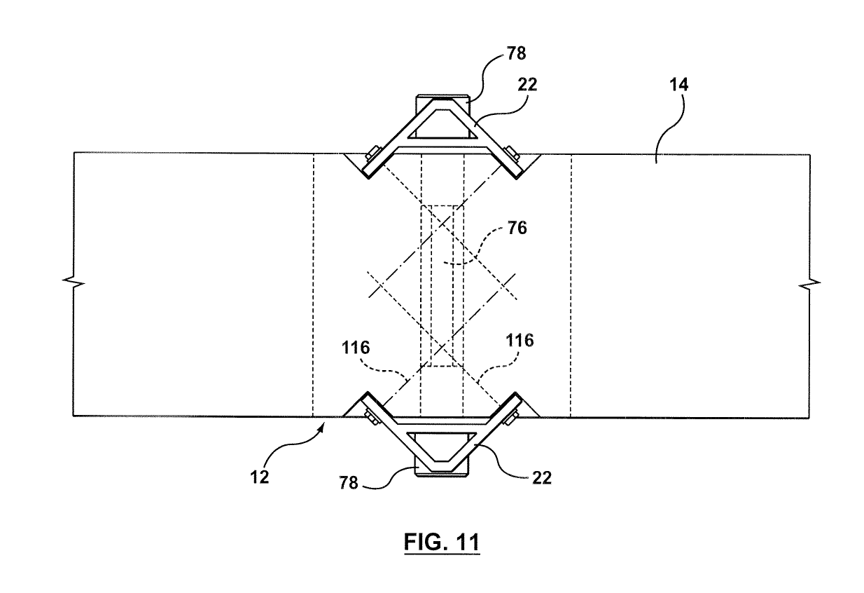

As shown in FIG. 11, anchoring fasteners 116, such as screws, nails, or other suitable fasteners, may be inserted through the arm holes 114 and driven into the respective underlying engagement surfaces 60, 62 of the grooves 56, 58 in the timber members 12, 14 to further secure the brace 22 to the timber members 12, 14. The use of anchoring fasteners 116 may tend to reduce the amount of sliding movement between the brace 22 and the timbers 12, 14. If anchoring fasteners 116 are used to secure the brace 22 to more than one of the timbers 12, 14, this may inhibit substantially all sliding movement between the brace 22 and the timbers 12, 14.

During assembly of the timber joint 10, the linkage apparatus 24 are generally received in the cap apertures 110, 112, and the web apertures 72, 74 of the braces 22, 23. As the couplings 78 are threadably engaged with the threaded rods 76, the couplings 78 may be received within the cap apertures 110, 112 with the shoulder 86 of the couplings 78 abutting the back face 38 of the web 30. As the couplings 78 are tightened, the shoulder 86 may tend to apply a clamping or squeezing force to the web 30 via the back surface 38 of the web 30, squeezing the braces 22, 23 together, and tending to tighten the timber joint 10. In this manner, the braces 22, 23 may be used to secure the post 12 and beam 14 together in a timber joint 10.

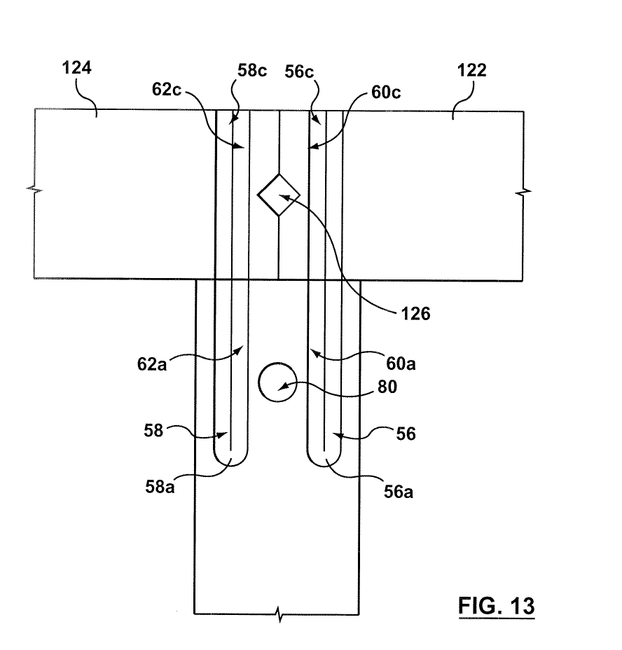

Referring now to FIGS. 12 and 13, another example of a timber joint 120 using braces 22, 23 is illustrated. Timber joint 120 includes the post 12 (as above) with first and second beams 122, 124 positioned on top of the post 12. The beams 122, 124 are generally coaxial to each other and perpendicular to the post 12, and the beams 122, 124 abut each other at a joint face J located above the top of the post 12.

Similar to the timber joint 10 as described above, linkage apparatus 24 may be used with braces 22, 23 to form the timber joint 120. In this embodiment, it is also desirable to secure the beams 122, 124 to each other to inhibit joint separation between beams 122, 124 to further encourage the formation of a secure timber joint 120.

As described above, the braces 22, 23 may be mounted within grooves 56, 58 having first and second groove segments 56a, 58a in the post 12. In this embodiment, a first groove segment 56c is provided in the first beam 122, and a second groove segment 58c is provided in the second beam 124.

During use, the first and second arm faces 44, 46 of the arms 40, 42 of the braces 22, 23 may engage with first and second engagement surfaces 60a, 62a in the post 12, a first engagement surface 60c in the first beam 122, and a second engagement surface 62c in the second beam 124.

In this embodiment, as the linkage apparatus 24 are tightened to squeeze the timber members 12, 122, 124 between the braces 22, 23, the arm faces 44, 46 tend to apply pressure against the corresponding engagement surfaces 60a, 60c, 62a, 62c in the grooves 56, 58. This pressure tends to result in both normal forces acting generally along the normal joint axis C, as well as transverse forces acting generally along the transverse joint axis B.

The normal forces tend to effect secure clamping of the post 12 to the beams 122, 124, while the transverse forces tend to force the first beam 122 and the second beam 124 towards each other along the joint face J, tending to secure the first and second beams 122, 124 together.

As shown in FIG. 13, the abutting ends of the beams 122, 124 may be shaped to define a diamond-shaped passageway 126 though which the uppermost linkage apparatus 24 may pass. This may be desirable to assist in centering the threaded rods 76 and/or linkage apparatus 24 within in the passageway 126. The diamond shaped passageway 126 may facilitate manufacturing, as a V-shaped routing bit could be used to form the passageway 126 in each end of the beams 122, 124, similar to or the same as a V-shaped routing bit that could be used to form the grooves 56, 58.

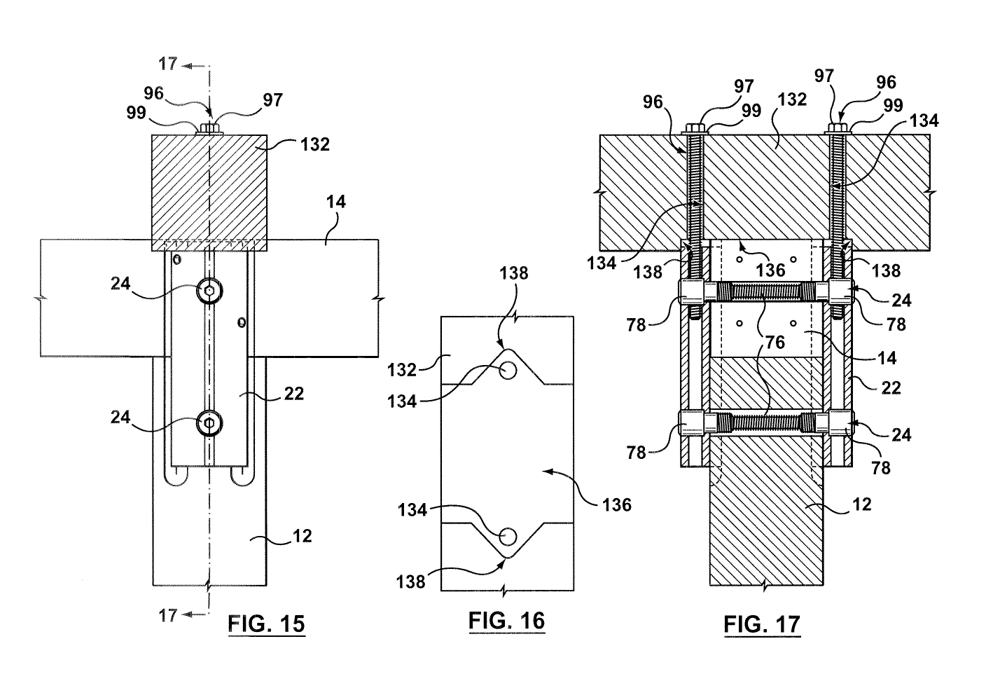

Referring now to FIGS. 14 to 17, another example of a timber joint 130 is illustrated. This timber joint 130 is similar to the timber joint 120, but includes an additional horizontal timber member or upper beam 132 that is mounted on top of the beams 122, 124 in a perpendicular relationship thereto. In this embodiment, one or more tie-bolts 96 or other transverse secondary fasteners may be used with the linkage apparatus 24 to secure the upper beam 132. This may be accomplished by threading the tie-bolts 96 into threaded portions of the cross bores 92 in the heads 82 of the couplings 78. The tie-bolts 96 may have a bolt head 97 that engages with a washer 99 to secure the upper beam 132 to the first and second timber members 12, 14 via holes 134 in the upper beam 132.

Alternatively, in some embodiments the tie-bolts 96 could be used with a brace (not shown) positioned above the upper beam 132 opposite the post 12 to secure the upper beam 132 to the post 12 and beam 14.

In some embodiments, as best shown in FIGS. 16 and 17, the lower side of the upper beam 132 in contact with the timber member 14 may include a recessed portion 136 to provide an interface surface between the upper beam 132 and the top surface of the timber member 14, and which may also inhibit relative movement of the upper beam 132 and the beam 14. In some embodiments, this recessed portion 136 may also include shaped portions 138 configured to accommodate the upper ends of the braces 22. These shaped portions 138 may be configured to permit sliding movement of the braces 22 relative to the upper beam 132 without interference therebetween.

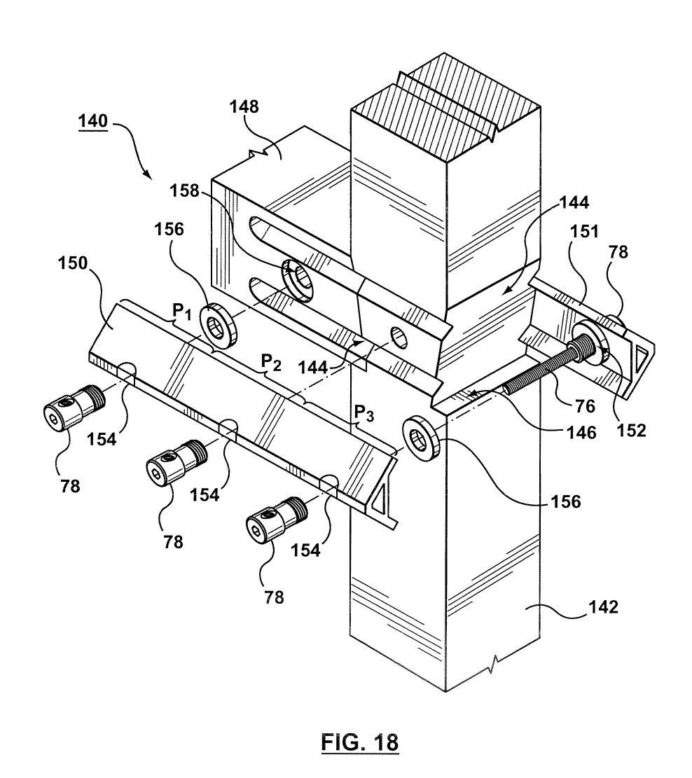

Referring now to FIG. 18, another example of a timber joint 140 is illustrated. In this timber joint 140, a vertical timber member or post 142 is provided having notched portions 144 in opposite sides thereof. The notched portions 144 may include support surfaces 146 for supporting the ends of one or more second horizontal beams 148 having abutment surfaces that bear against respective support surfaces 146 on opposite sides of post 142.

Two braces 150, 151 according to another embodiment may be provided on opposite sides of the timber post 142 and beams 148. Each of braces 150, 151 generally has three timber connection portions P₁, P₂ and P₃, each with a respective web aperture 152 and cap aperture 154, for engaging the timber post 142 and beams 148. The braces 150, 151 are used to secure the timber post 142 and beams 148 similar to as described above.

In some embodiments, the linkage apparatus 24 may include one or more shear washers 156 that are received in one or more counter-sunk portions 158 provided in at least one of the post 142 and beams 148. The shear washers 156 may bear against the counter-sunk portions 158 of the beams 148 and the front face of the braces 150, 151, and may tend to impede relative shearing or movement of the beams 148 and post 142, and in particular may act to inhibit joint separation between the post 142 and beams 148. The shear washers 156 may be made of metal or any other suitable material, such as a rigid or resilient rubber, plastic or other material.

It will be understood that the shear washers 156 could be used with other embodiments disclosed herein. For example, the shear washers 156 and countersunk portions 158 could be used with the embodiment described with reference to FIGS. 1 to 11 and may tend to further inhibit joint separation between the post 12 and beam 14 along the longitudinal axis A.

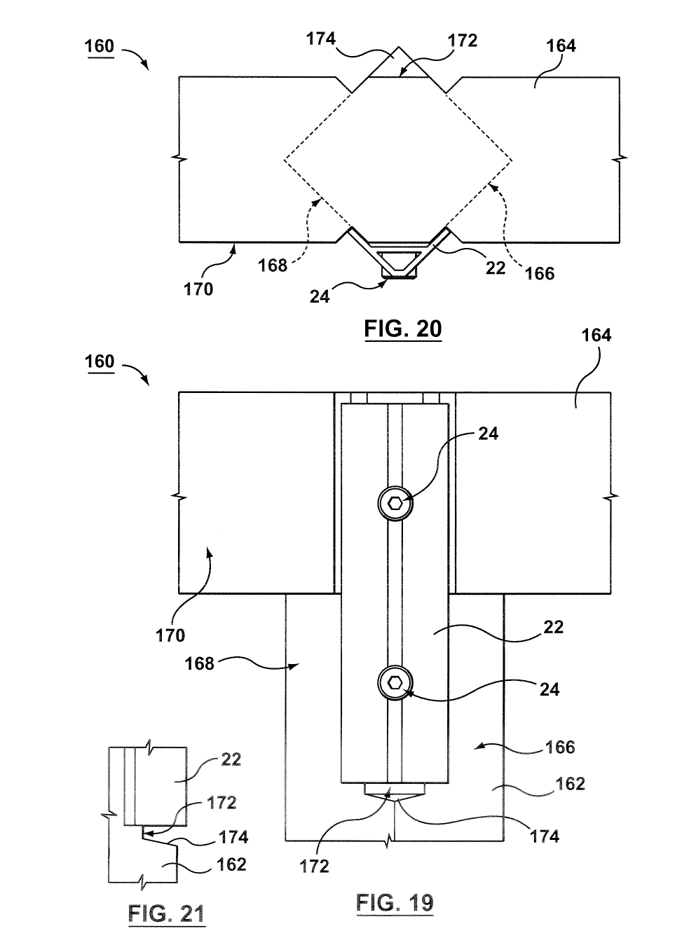

Referring now to FIGS. 19 to 21, another example of a timber joint 160 is illustrated. Timber joint 160 has a generally square first timber member or post 162, rotated at an angle of 45 degrees about its longitudinal axis with respect to a second timber member or beam 164 such that respective front faces 166, 168 of the post 162 are oriented at 45 degrees to a front face 170 of the beam 164.

In this embodiment, the brace 22 may be used to secure the post 162 to the beam 164 without spaced grooves 56, 58 being provided in the post 162, since the arms of the brace 22 may bear directly against inclined side faces 166, 168 of the post 162 due to the orientation of the post 162. The inclined side faces 166, 168 of the post 162 provide first and second engagement surfaces for engaging the front faces 44, 46 of the brace 22.

Notches or recessed portions 172 may be provided in opposite front and rear corners of the timber post 162 to provide clearance for the brace 22 to be installed onto the post 162. The recessed portions 172 may be provided by removing material from the corner sections of timber post 162, and may include a lower shelf 174, as best shown in FIG. 21. In this manner, the brace 22 may be mounted to the timber post 162 and beam 164 without interfering with the post 162, allowing the arm faces 44, 46 of the brace 22 to bear against the side faces 166, 168 of the post 162.

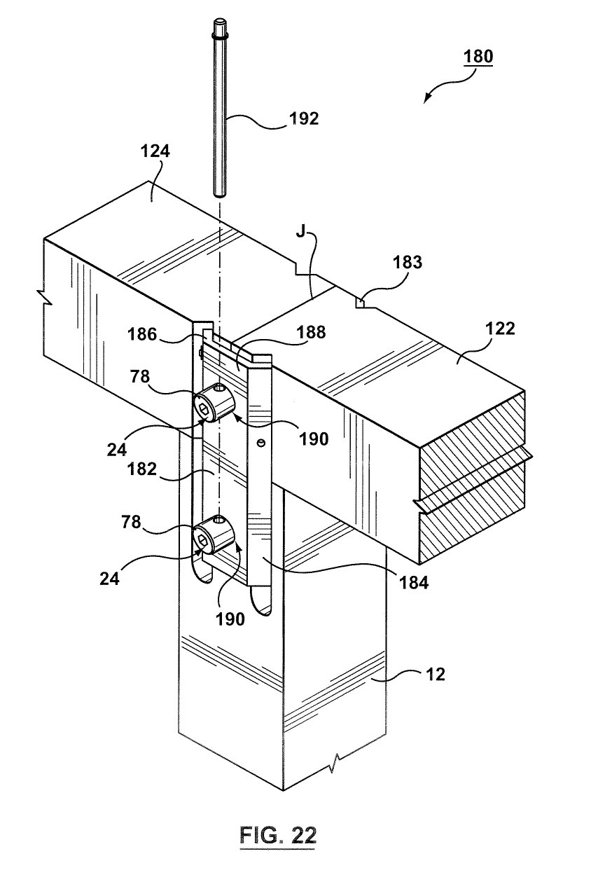

Referring now to FIG. 22, another example of a timber joint 180 is shown. Timber joint 180 includes the post 12 joined to the beam 122, 124 using braces 182, 183 as shown. Braces 182, 183 are similar to braces 22, 23 but have no cap portion 98. Braces 182, 183 generally have a first arm 184 and a second arm 186 connected by a transverse web member 188 having web apertures 190 defined therein. Linkage apparatus 24 (as described above) or another suitable fastening device such as a bolt, nut and washer combination, may be used to secure the braces 182, 183 together to form the timber joint 180.

In some embodiments, the couplings 78 of the linkage apparatus 24 may be secured together with a pin 192 (as shown in FIG. 22) or other securing member that passes through the cross-bores 92 in both couplings 78 to prevent relative rotation of the couplings 78. The pin 192 tends to inhibit relative rotation of each of the couplings 78. In some embodiments, the pin 192 or other securing member may be externally threaded to engage with internal threads in the cross-bores 92. In other embodiments, the pin 192 or other securing member may be provided without external threads, and may be slidable into and out of the cross-bores 92.

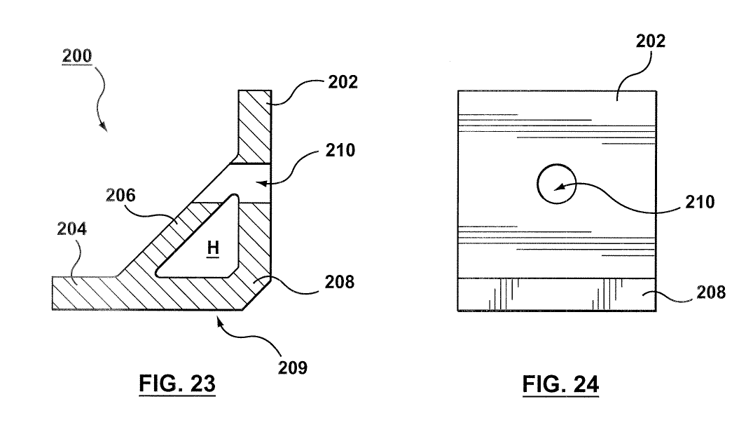

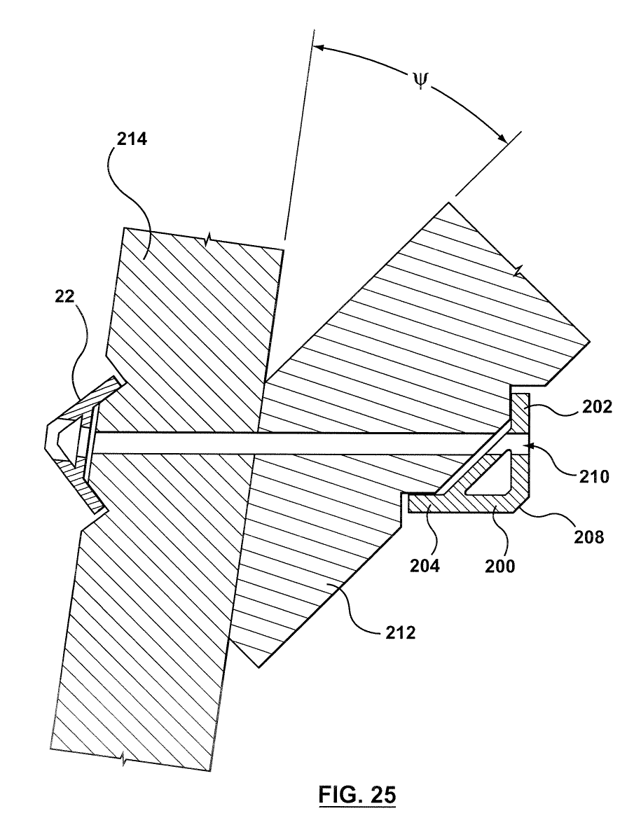

Turning now to FIGS. 23 to 25, in some embodiments a brace 200 may be provided for use with structural members oriented at different angles, such as beams 212 and 214 oriented at an angle ψ. The brace 200 generally includes first and second arms 202, 204 connected via a transverse web 206. The first and second arms 202, 204 extend rearwardly and converge at a spine member 208, defining a cap portion 209 containing channel H. The brace 200 also includes an aperture 210 therein located proximate the first arm 202, and which is generally offset from the spine member 208, and which may pass through one or both of the arms 202, 204 and the web 206. The brace 200 may be used on an outer surface of the first beam 212 for connection with the second beam 214. Depending on the configuration of the second beam 214, brace 22 as described above may be used on the outer surface of the second beam 214.

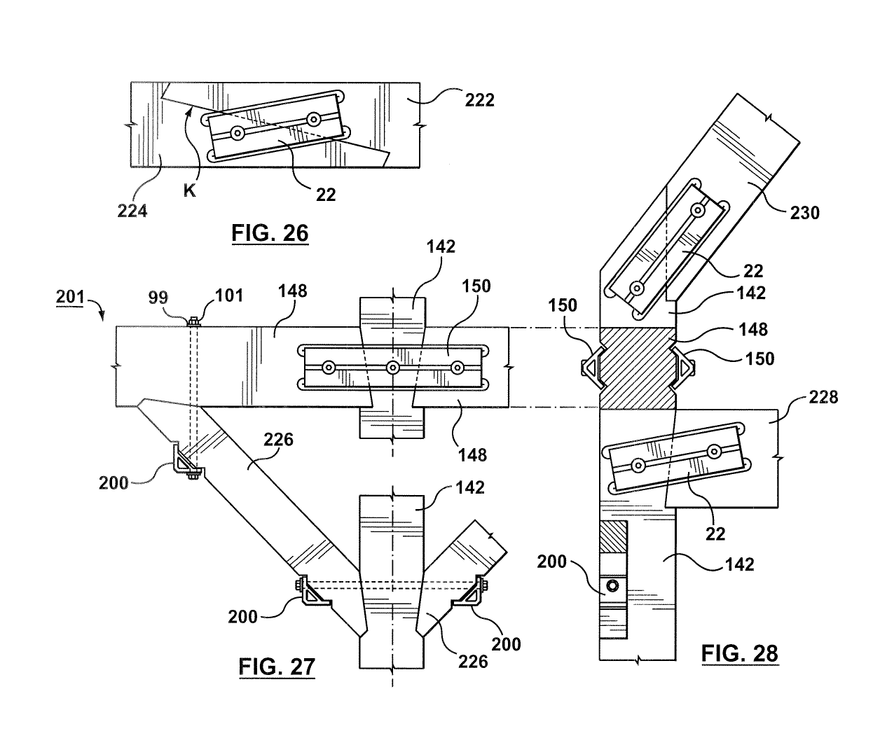

Turning now to FIGS. 26 to 32, various other embodiments are shown having different structural member configurations.

FIG. 26 shows an example of a scarf joint where timber members 222 and 224 are coaxial with an angled joint face K therebetween. Timber members 222, 224 are secured together using brace 22 oriented as shown. In some examples, shear washers 156 may be used with this joint to further inhibit joint separation. In other examples, this joint could be provided without shear washers 156, for example where the distal ends 48, 50 of the braces 22 are provided in contact with the free walls 64, 66 of the grooves 56, 58.

FIGS. 27 and 28 show a structural assembly 201 incorporating a number of timber members and braces. As shown, the structural assembly 201 includes a vertical post 142 secured to beams 148 via a brace 150, and at least one of the beams 148 is secured to angled beams 226 using a brace 200 at one face thereof and a washer 99 and nut 101 on the opposite face thereof. Angled beams 226 are in turn secured to the vertical post 142 also using braces 200. Also secured to the vertical post 142 is a horizontal beam 228 and a rafter beam 230 (via braces 22), as shown in FIG. 28.

The first and second arms 40, 42 of the braces 22 may tend to act as shear plates when the braces 22 are installed at an angle offset from the angle of the longitudinal axes of both the post 142 and the beam 228. In such cases, the orientation of the first and second arms 40, 42 may tend to further inhibit joint separation between the beam 228 and the post 142 along the longitudinal axis of the beam 228.

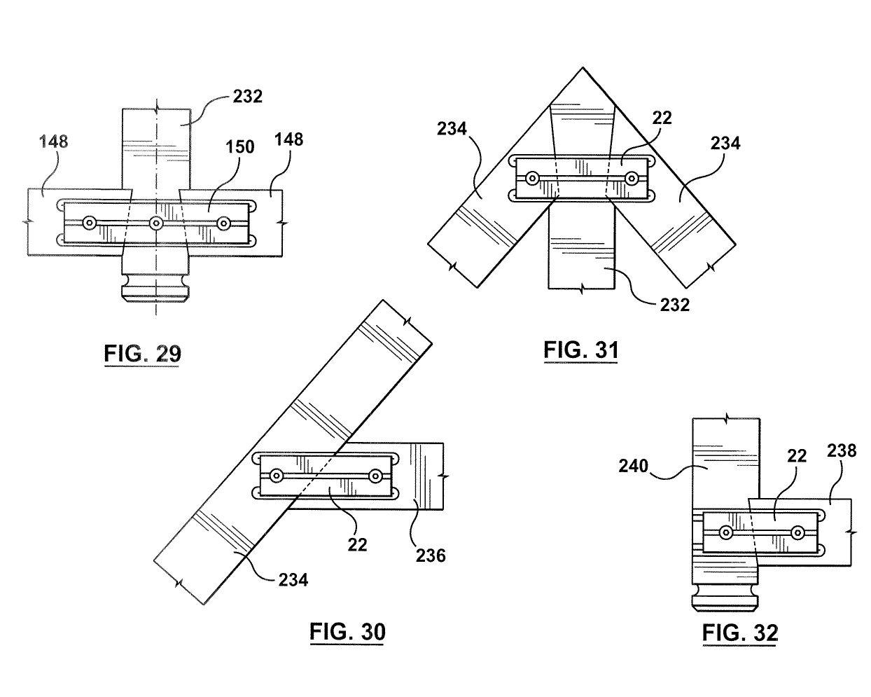

FIG. 29 shows beams 148 secured to a king post 232 using a brace 150.

FIG. 30 shows a rafter beam 234 connected to a horizontal beam 236 using a brace 22.

FIG. 31 shows rafter beams 234 connected to the upper end of a king post 232 using a brace 22.

FIG. 32 shows a hammer beam 238 connected to a hammer-post 240 via a brace 22.

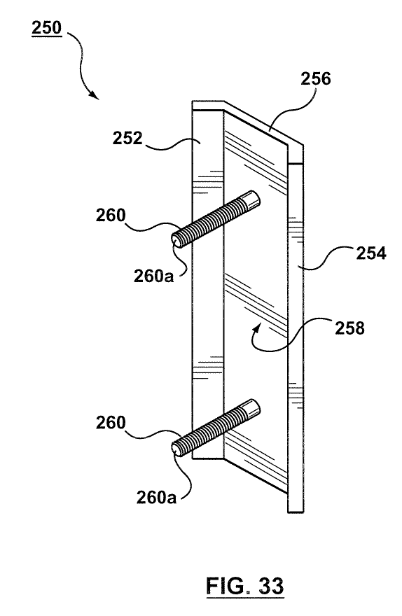

Turning now to FIG. 33, a brace 250 according to another embodiment is shown. Brace 250 has a first arm 252 and a second arm 254 connected by a transverse web 256. Extending outwardly from the front face 258 of the web 256 are two fastener or connector members, shown here as threaded members 260. The threaded members 260 are rigidly secured to the front face 258 of the brace 250. In some embodiments, the connector members can be permanently or semi-permanently secured to the brace 250. In other embodiments, the connector members could be removably secured to the brace 250.

Brace 250 may be usable to connect timber beams and posts together without the need to provide a separate linkage apparatus 24 or apertures within the brace 250. For example, a nut 101 or one or more couplings 78 may be secured to the free ends 206a of the threaded members 260.

In some embodiments, brace 250 could be used with a differently configured brace, such as brace 22, opposite the brace 250. In other embodiments, the brace 250 could be used without an opposite brace.

What has been described is merely illustrative of the application of some embodiments of the invention. Other systems, apparatuses and methods may be implemented by those skilled in the art without departing from the present invention, the scope of which is defined by the following claims. In particular, various apparatus described above provide an example of one or more embodiment of any claimed inventions. No embodiment described limits any claimed invention and any claimed invention may cover systems, apparatus or methods that are not described above. The claimed inventions are not limited to systems, apparatus or methods having all of the features of any one apparatus or process described above or to features common to multiple or all of the systems, apparatus or methods described above. It is possible that systems, apparatus or methods described above are not an embodiment of any claimed invention. The applicants, inventors or owners reserve all rights that they may have in any invention disclosed in systems, apparatus or methods described above that is not claimed in this document, for example the right to claim such an invention in a continuing or divisional application and do not intend to abandon, disclaim or dedicate to the public any such invention by its disclosure in this document.

1. A brace for joining a plurality of structural members, comprising:
a) a web extending lengthwise along at least a portion of a connector axis, the web having laterally opposite first and second web side edges and opposed web front and web back faces extending between the first and second web side edges;
b) a first arm extending forwardly from the first web side edge relative to the front face of the web, the first arm presenting a first arm face; and
c) a second arm extending forwardly from the second web side edge relative to the front face of the web, the second arm presenting a second arm face;
d) wherein the first and second arm faces are inclined outwardly from each other at a first angle.

2. The brace of claim 1, wherein the web comprises at least one web aperture therein configured for receiving a fastening device for fastening the brace to at least one of the structural members.

3. The brace of claim 2, wherein the at least one web aperture comprises a first web aperture located in a first portion of the web for securing the brace to a first structural member, and a second web aperture located in a second portion of the web for securing the brace to a second structural member.

4. The brace of claim 1, wherein at least one of the structural members has first engagement surfaces and second engagement surfaces spaced from the first engagement surfaces, and the first arm face is configured for bearing against the first engagement surfaces and the second arm face is configured for bearing against the second engagement surfaces.

5. The brace of claim 4, wherein the first angle is a pressure angle, and the first and second engagement surfaces are inclined relative to each other at a second engagement angle corresponding to the pressure angle.

6. The brace of claim 4, wherein the first engagement surfaces and second engagement surfaces are provided in spaced apart grooves provided in one or more faces of the structural members.

7. The brace of claim 1, wherein a portion of the first arm and a portion of the second arm extend rearwardly of the web to define a cap portion, and the cap portion is provided with a longitudinal channel extending lengthwise of the brace, the channel being defined by at least the back face of the web, an interior surface of the first arm, and an interior surface of the second arm.

8. The brace of claim 7, wherein the cap portion has at least one cap aperture therein in registration with the at least one web aperture in the web.

9. The brace of claim 8, wherein the at least one cap aperture is larger in diameter than the at least one web aperture and is configured to receive the fastening device such that the fastening device can bear against the back face of the web.

10. The brace of claim 1, wherein the first angle is between 45 and 135 degrees.

11. The brace of claim 1, wherein the first angle is approximately 90 degrees.

12. The brace of claim 1, further comprising at least one arm aperture in at least one of the first arm and the second arm, the at least one arm aperture for receiving at least one arm fastener to further secure the brace to at least one of the structural members.

13. A connector apparatus for joining a plurality of structural members, comprising:
a) a brace comprising:
i) a web extending lengthwise along at least a portion of a connector axis, the web having laterally opposite first and second web side edges and opposed web front and web back faces extending between the first and second web side edges, the web having at least one web aperture therein;
ii) a first arm extending forwardly from the first web side edge relative to the front face of the web, the first arm presenting a first arm face; and
iii) a second arm extending forwardly from the second web side edge relative to the front face of the web, the second arm presenting a second arm face;
iv) wherein the first and second arm faces are inclined outwardly from each other at a first angle; and
b) a fastening device shaped for engaging the web and for extending through the at least one web aperture and at least one of the structural members so as to secure the brace to the structural members.

14. The connector apparatus of claim 13, wherein the fastening device comprises a coupling having a head portion shaped to bear against the back face of the web and a connector member securable to the coupling and shaped to extend through the at least one structural member to secure the brace to the structural members.

15. The connector apparatus of claim 14, wherein the coupling further comprises a barrel having a threaded bore, and the connector member comprises a threaded rod portion shaped to releasably engage the threaded bore of the barrel.

16. The connector apparatus of claim 13, wherein the first angle is a pressure angle, and at least one of the structural members have first engagement surfaces and second engagement surfaces spaced from the first engagement surfaces, the first and second engagement surfaces inclined relative to each other at a second engagement angle corresponding to the pressure angle, the second engagement angle selected such that the first arm face bears against the first engagement surfaces on the at least one structural member and the second arm face bears against the second engagement surfaces on the at least one structural member when the brace is secured to the structural members.

17. A connector apparatus for a joint having at least two structural members, the connector apparatus comprising:
a) a first brace and a second brace positionable in an opposing relationship on opposite faces of the structural members, each brace comprising:
i) a web extending lengthwise along at least a portion of a connector axis, the web having laterally opposite first and second web side edges and opposed web front and web back faces extending between the first and second web side edges, the web having at least one web aperture therein;
ii) a first arm extending forwardly from the first web side edge relative to the front face of the web, the first arm presenting a first arm face; and
iii) a second arm extending forwardly from the second web side edge relative to the front face of the web, the second arm presenting a second arm face;
iv) wherein the first and second arm faces are inclined outwardly from each other at a first angle; and
b) a fastening device shaped for engaging the webs of the first and second braces and shaped for extending through the at least one web aperture and at least one of the structural members and being adjustable to selectively urge the opposing first and second braces towards each other to bear against the opposite faces of the structural members.

18. The connector apparatus of claim 17 wherein the fastening device comprises a linkage apparatus having:
a) a first coupling for bearing against the first brace;
b) a second coupling for bearing against the second brace; and
c) a connector member for engaging with the first coupling and the second coupling to draw the first and second couplings towards each other to selectively urge the opposing first and second braces to bear against the opposite faces of the structural members

19. The connector apparatus of claim 18, wherein each of the first coupling and the second coupling comprises:
a) a head portion for bearing against the back face of the webs of the first and second braces; and
b) a barrel portion connected to the head portion and shaped for engaging the at least one web aperture and a passageway in at least one structural member, the barrel portion having a threaded bore;
c) wherein the connector member comprises a threaded rod portion releasably securable to the threaded bore of the barrel portion in the first and second couplings and being shaped for extending through an aperture in the at least one structural member to join the first brace to the second brace.

20. A structural joint, comprising:
a) a first structural member having a first abutment face, and a first front face;
b) a second structural member having a second abutment face for engaging the first abutment face of the first structural member, and a second front face generally coplanar with the first front face when the second abutment face engages the first abutment face;
c) at least one brace having a first portion for engaging the first front face, and a second portion for engaging the second front face, the at least one brace comprising:
i) a web extending lengthwise along at least a portion of a connector axis, the web having laterally opposite first and second web side edges and opposed web front and web back faces extending between the first and second web side edges, the web having at least one web aperture therein;
ii) a first arm extending forwardly from the first web side edge relative to the front face of the web, the first arm presenting a first arm face; and
iii) a second arm extending forwardly from the second web side edge relative to the front face of the web, the second arm presenting a second arm face;
iv) wherein the first and second arm faces are inclined outwardly from each other at a first angle; and
d) at least one fastening device couplable to the web of the at least one brace and for extending through the at least one web aperture, the fastening device configured for securing the at least one brace against the first and second front faces of the first and second structural members.

21. The structural joint of claim 20, wherein the first and second structural members comprise first engagement surfaces and second engagement surfaces spaced apart from the first engagement surfaces and inclined with respect to the first engagement surfaces at a second engagement angle, wherein the first and second arm faces of the at least one brace are configured to bear against the first and second engagement surfaces respectively when the at least one brace is secured against the first and second front faces of the first and second structural members.

22. A linkage apparatus for use in securing at least one brace to a plurality of structural members, each brace having a web extending lengthwise along at least a portion of a connector axis, opposed web front and web back faces, and at least one web aperture therein, the linkage apparatus comprising:
a) a first coupling member having a head portion for bearing against the web back face of a first brace of the at least one brace, and a barrel portion for engaging the at least one web aperture in the first brace; and
b) a connector member engagable with the barrel portion of the first coupling member and being shaped for passing through an aperture in at least one of the structural members to secure the first brace against first faces of the structural members.

23. The linkage apparatus of claim 22, further comprising a second coupling member opposite the first coupling member, and wherein the barrel portion of the first coupling comprises a threaded bore, and the connector member comprises a threaded rod portion shaped to releasably engage with the threaded bore of the barrel portion and being adjustable to selectively urge the first and second couplings towards each other to bear the first brace against the first faces of the plurality of structural members

24. The linkage apparatus of claim 22, wherein the head portion of the first coupling member has a cross-bore, and further comprising a locking fastener for engaging with the cross-bore when the first coupling member is engaged with the structural members, the locking fastener being configured to inhibit rotation of the first coupling member.

25. The linkage apparatus of claim 24, wherein the cross-bore has an internally threaded portion and the locking fastener has a threaded portion for releasably engaging with the internally threaded portion.
